(19) United States
(12) Patent Application Publication
(10) Pub. No.: US 2023/0038247 A1
(43) Pub. Date: Feb. 9, 2023

(54) APPARATUS FOR USE IN PULLING OR LIFTING AN OBJECT

(71) Applicant: Brilliant Ideas LTD, Ashbourne Derbyshire (GB)

(72) Inventor: Christopher Jon Massey, Ashbourne Derbyshire (GB)

(21) Appl. No.: 17/790,665

(22) PCT Filed: Dec. 18, 2020
(86) PCT No.: PCT/GB2020/053314

§ 371 Date: Jul. 1, 2022

(30) Foreign Application Priority Data
Jan. 2, 2020 (GB) 2000028.7

(51) Int. Cl. E04G 21/14; E04G 21/16

(52) U.S. Cl. CPC E04G 21/142; E04G 21/167

(57) ABSTRACT

An apparatus for use in lifting or pulling an object. The apparatus comprises a female part including a hole extending into the female part. The hole includes a first portion and a second portion, the first portion being narrower than the second portion. The apparatus further comprises a sleeve comprising a plurality of arms, at least one of which is flexible. The plurality of arms define a channel, the arms being configured for insertion into the hole in the female part such that distal portions of the arms are at least partially positioned in the second portion of the hole. The apparatus further comprises a male part, for insertion into the channel of the sleeve, comprising a distal stop.

### TECHNOLOGICAL FIELD

Embodiments of the present disclosure relate to an apparatus for use in pulling or lifting an object. Some relate to an apparatus for pulling or lifting a concrete slab.

### BACKGROUND

Lifting heavy objects such as concrete slabs requires a strong connection between a lifting device, such as a crane, and the object. Conventional lifting systems for concrete slabs include a metal anchor, which is set into the concrete slab. The lifting device then couples to the anchor to lift the concrete slab. Specific anchors are used, depending on the weight to be lifted or the specific application.

The metal anchor in these systems can also degrade over time, leading to difficulties in moving the slabs and reusing the anchor several years after they have been placed down. As the anchors are made from metal, which is expensive relative to concrete, it is desirable to use a minimal amount of material. This reduces the area of the anchor in contact with the concrete, and means that the anchor sits more shallowly in the concrete. This limits the load that can safely pass through the anchor.

### BRIEF SUMMARY

According to various, but not necessarily all, embodiments there is provided an apparatus for use in lifting or pulling an object, the apparatus comprising: a female part including a hole extending into the female part, wherein the hole includes a first portion and a second portion, the first portion being narrower than the second portion; a sleeve comprising a plurality of arms, at least one of which is flexible, the plurality of arms defining a channel, the arms being configured for insertion into the hole in the female part such that distal portions of the arms are at least partially positioned in the second portion of the hole; and a male part, for insertion into the channel of the sleeve, comprising a distal stop, wherein the male part is arranged such that, when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

The distal stop may taper radially outwardly from the male part. The distal stop may be provided by a distal end of a recess in the distal portion of the male part.

The distal end of the recess of the male part may be tapered. The proximal end of the recess of the male part may be tapered.

The at least one flexible arm may include an internal projection extending into the channel for insertion into the recess. The internal projection of the at least one flexible arm may include a tapered portion at its distal end, to enable the projection to be slidably removed from the recess of the male part. The projection may be shaped to substantially correspond to the shape of the recess in the distal portion.

The distal end of the male part may include a tapered portion to facilitate location of the male part into the channel.

The distal end of the at least one flexible arm may include an outer tapered surface extending radially outwardly from the at least one flexible arm in a direction away from the channel, to facilitate location of the at least one flexible arm into the hole.

The distal end of the at least one flexible arm may include an inner tapered surface extending into the channel from the at least one flexible arm, such that movement of the distal end of the at least one flexible arm over the distal stop of the male part is facilitated.

The apparatus may further include a release means for use in releasing the male part from the channel of the sleeve. The release means may include an external flange on the sleeve, with the external flange being for enabling a user to hold the sleeve in the hole, such that the distal stop of the male part can be pulled through the channel.

The male part may include a mounting portion. The mounting portion may include fastening means for fastening the male part to a lifting or pulling device. The fastening means may comprise internal threading.

The distal portion of the at least one flexible arm of the sleeve may be made from metal.

A part of the at least one flexible arm of the sleeve may be made from a resilient plastics material. The at least one flexible arm of the sleeve may include a thinned portion for increasing the flexibility of the at least one flexible arm.

The sleeve may comprise between two and twelve flexible arms. Possibly, the sleeve may comprise between four and eight flexible arms.

The hole may include an outer opening, and the first portion of the hole may be positioned between the outer opening and the second portion of the hole.

The hole may include an abutment surface between the first portion and the second portion, the abutment surface extending radially outwardly from the first portion to the second portion. The abutment surface may be tapered.

The at least one flexible arm of the sleeve may include an external projection extending radially outwardly from the channel, and the external projection may be for abutting against the abutment surface of the female part.

The hole may be a through hole, or the hole may be a blind hole.

The second portion of the hole may include a tapered section adjacent to the abutment surface, which tapered section may extend radially outwardly.

According to various, but not necessarily all, embodiments there is provided an apparatus for use in lifting or pulling an object, the apparatus comprising: a female part including a hole extending into the female part, wherein the hole includes a first portion and a second portion, the first portion being narrower than the second portion; a sleeve comprising a plurality of arms, at least one of which is flexible, the plurality of arms defining a channel, the arms being configured for insertion into the hole in the female part such that distal portions of the arms are at least partially positioned in the second portion of the hole, wherein the channel is for receiving a male part including a distal stop, wherein the distal portion of the at least one flexible arm includes an abutment surface for abutting against the distal stop of the male part, such that when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

The at least one flexible arm may include an internal projection extending into the channel. The internal projection of the at least one flexible arm may include a tapered portion at its distal end.

The distal end of the at least one flexible arm may include an outer tapered surface extending radially outwardly from the at least one flexible arm in a direction away from the channel, to facilitate location of the at least one flexible arm into the hole.

The distal end of the at least one flexible arm may include an inner tapered surface extending into the channel from the at least one flexible arm, such that movement of the distal end of the at least one flexible arm over the distal stop of the male part is facilitated.

The apparatus may further include a release means for use in releasing the male part from the channel of the sleeve. The release means may include an external flange on the sleeve, with the external flange being for enabling a user to hold the sleeve in the hole, such that the distal stop of the male part can be pulled through the channel.

The distal portion of the at least one flexible arm of the sleeve may be made from metal.

A part of the at least one flexible arm of the sleeve may be made from a resilient plastics material. The at least one flexible arm of the sleeve may include a thinned portion for increasing the flexibility of the at least one flexible arm.

The sleeve may comprise between two and twelve flexible arms. Possibly, the sleeve may comprise between four and eight flexible arms.

The hole may include an outer opening, and the first portion of the hole may be positioned between the outer opening and the second portion of the hole.

The hole may include an abutment surface between the first portion and the second portion, the abutment surface extending radially outwardly from the first portion to the second portion. The abutment surface may be tapered.

The at least one flexible arm of the sleeve may include an external projection extending radially outwardly from the channel, and the external projection may be for abutting against the abutment surface of the female part.

The hole may be a through hole, or the hole may be a blind hole.

The second portion of the hole may include a tapered section adjacent to the abutment surface, which tapered section may extend radially outwardly.

An apparatus for use in lifting or pulling an object, the apparatus comprising: a sleeve comprising a plurality of arms, at least one of which is flexible, the plurality of arms defining a channel, and the arms are configured for insertion into a hole of a female part, the hole including a first portion and a second portion, the first portion of the hole being narrower than the second portion of the hole, such that distal portions of the arms of the sleeve are at least partially positioned in the second portion of the hole when the arms are inserted into the hole; and a male part, for insertion into the channel of the sleeve, comprising a distal stop, wherein the male part is arranged such that, when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

The distal stop may taper radially outwardly from the male part. The distal stop may be provided by a distal end of a recess in the distal portion of the male part.

The distal end of the recess of the male part may be tapered. The proximal end of the recess of the male part may be tapered.

The at least one flexible arm may include an internal projection extending into the channel for insertion into the recess. The internal projection of the at least one flexible arm may include a tapered portion at its distal end, to enable the projection to be slidably removed from the recess of the male part. The projection may be shaped to substantially correspond to the shape of the recess in the distal portion.

The distal end of the male part may include a tapered portion to facilitate location of the male part into the channel.

The distal end of the at least one flexible arm may include an outer tapered surface extending radially outwardly from the at least one flexible arm in a direction away from the channel, to facilitate location of the at least one flexible arm into the hole.

The distal end of the at least one flexible arm may include an inner tapered surface extending into the channel from the at least one flexible arm, such that movement of the distal end of the at least one flexible arm over the distal stop of the male part is facilitated.

The apparatus may further include a release means for use in releasing the male part from the channel of the sleeve. The release means may include an external flange on the sleeve, with the external flange being for enabling a user to hold the sleeve in the hole, such that the distal stop of the male part can be pulled through the channel.

The male part may include a mounting portion. The mounting portion may include fastening means for fastening the male part to a lifting or pulling device. The fastening means may comprise internal threading.

The distal portion of the at least one flexible arm of the sleeve may be made from metal.

A part of the at least one flexible arm of the sleeve may be made from a resilient plastics material. The at least one flexible arm of the sleeve may include a thinned portion for increasing the flexibility of the at least one flexible arm.

The sleeve may comprise between two and twelve flexible arms. Possibly, the sleeve may comprise between four and eight flexible arms.

According to various, but not necessarily all, embodiments there is provided a female part including a hole extending into the female part, wherein the hole includes a first portion and a second portion, the first portion being narrower than the second portion.

The hole may include an outer opening, and the first portion of the hole may be positioned between the outer opening and the second portion of the hole.

The hole may include an abutment surface between the first portion and the second portion, the abutment surface extending radially outwardly from the first portion to the second portion. The abutment surface may be tapered.

The hole may be a through hole, or the hole may be a blind hole.

The second portion of the hole may include a tapered section adjacent to the abutment surface, which tapered section may extend radially outwardly.

According to various, but not necessarily all, embodiments there is provided a sleeve comprising a plurality of arms, at least one of which is flexible, the plurality of arms defining a channel, the arms being configured for insertion into a hole including a first portion and a second portion, the first portion of the hole being narrower than the second portion of the hole, such that distal portions of the arms of the sleeve are at least partially positioned in the second portion of the hole when the arms are inserted into the hole.

The at least one flexible arm may include an internal projection extending into the channel. The internal projection of the at least one flexible arm may include a tapered portion at its distal end.

The distal end of the at least one flexible arm may include an outer tapered surface extending radially outwardly from the at least one flexible arm in a direction away from the channel, to facilitate location of the at least one flexible arm into the hole.

The distal end of the at least one flexible arm may include an inner tapered surface extending into the channel from the at least one flexible arm.

The sleeve may include an external flange on the sleeve, with the external flange being for enabling a user to hold the sleeve in the hole.

The distal portion of the at least one flexible arm of the sleeve may be made from metal.

A part of the at least one flexible arm of the sleeve may be made from a resilient plastics material. The at least one flexible arm of the sleeve may include a thinned portion for increasing the flexibility of the at least one flexible arm.

The sleeve may comprise between two and twelve flexible arms. Possibly, the sleeve may comprise between four and eight flexible arms.

According to various, but not necessarily all, embodiments there is provided a male part for insertion into a channel, the male part comprising a distal stop.

The distal stop may taper radially outwardly from the male part. The distal stop may be provided by a distal end of a recess in the distal portion of the male part.

The distal end of the recess of the male part may be tapered. The proximal end of the recess of the male part may be tapered.

The distal end of the male part may include a tapered portion to facilitate location of the male part into the channel.

The male part may include a mounting portion. The mounting portion may include fastening means for fastening the male part to a lifting or pulling device. The fastening means may comprise internal threading.

### BRIEF DESCRIPTION

Some examples will now be described with reference to the accompanying drawings in which:

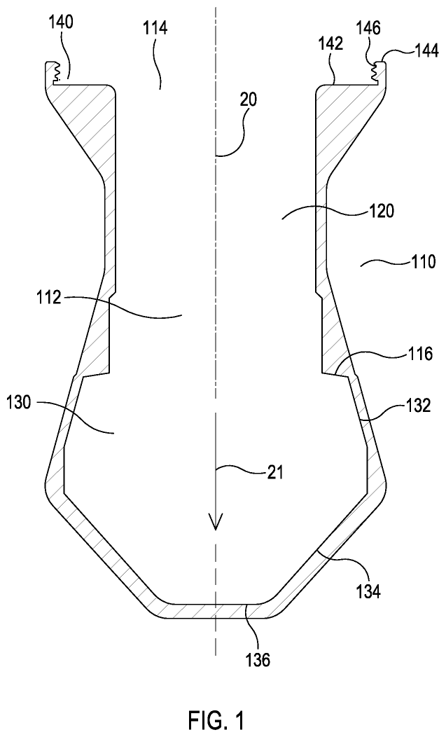

FIG. 1 is a cross-sectional view of a female part of a first apparatus according to the disclosure;

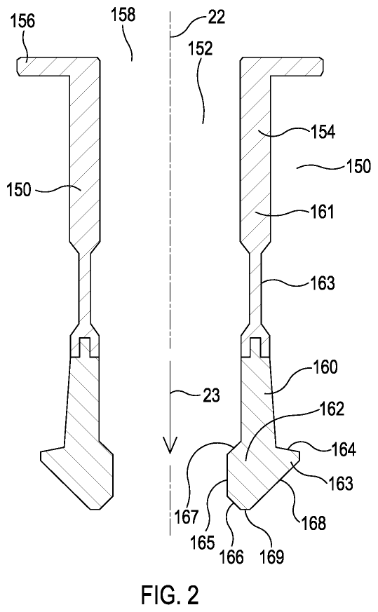

FIG. 2 is a cross-sectional view of a sleeve of the first apparatus;

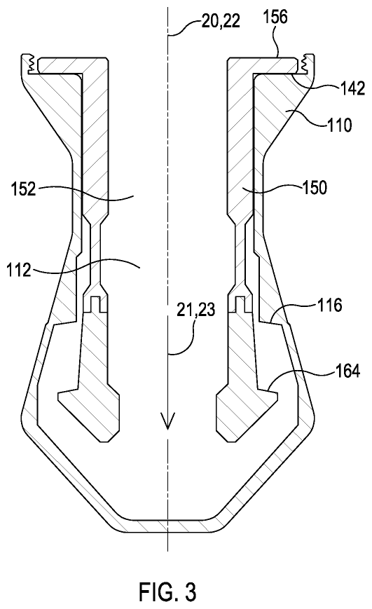

FIG. 3 is a cross-sectional view of the sleeve of the first apparatus inserted into the female part of the first apparatus;

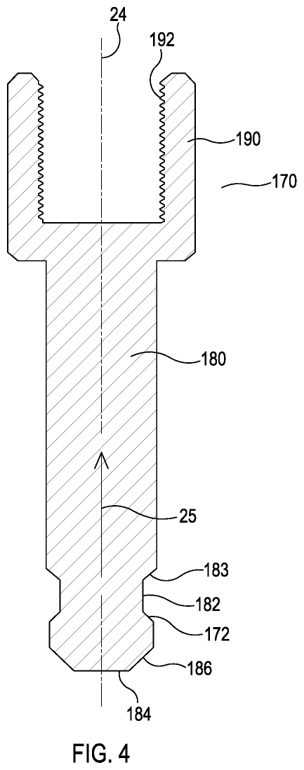

FIG. 4 is a cross-sectional view of a male part of the first apparatus;

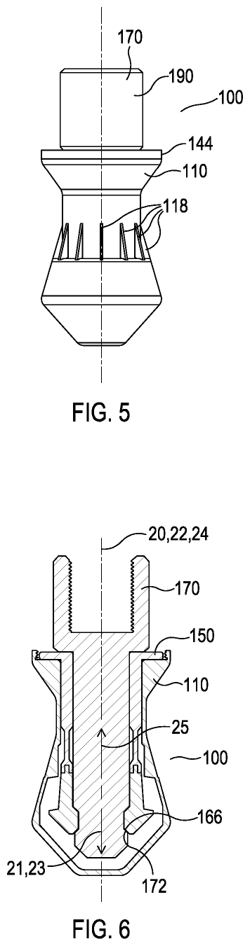

FIG. 5 is a side view of the first apparatus in the first condition;

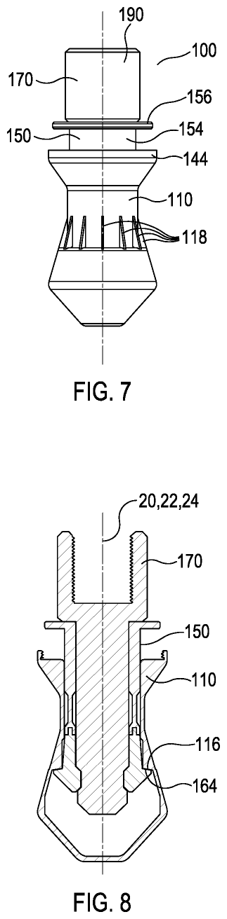

FIG. 6 is a cross-sectional view of the first apparatus in the first condition;

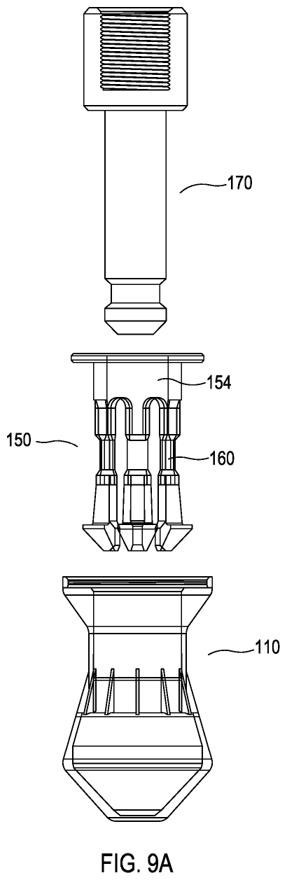

FIG. 7 is a side view of the first apparatus in a second condition;

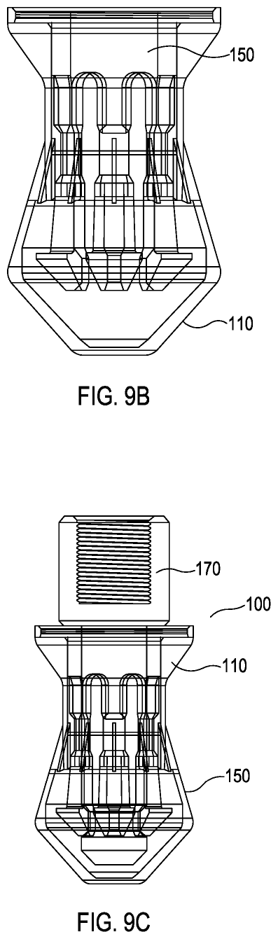

FIG. 8 is a cross-sectional view of the first apparatus in the second condition;

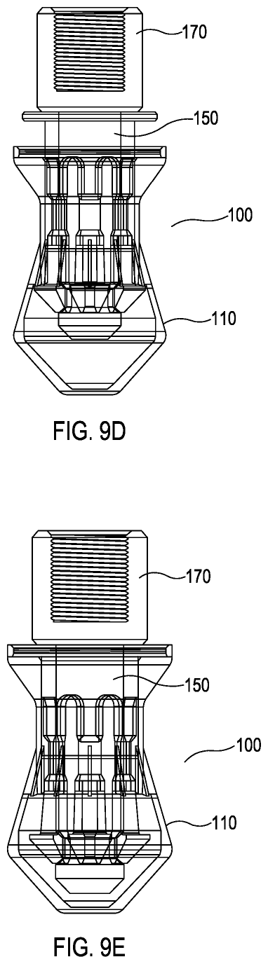

FIGS. 9A to 9F are see-through views showing the operation of the first apparatus;

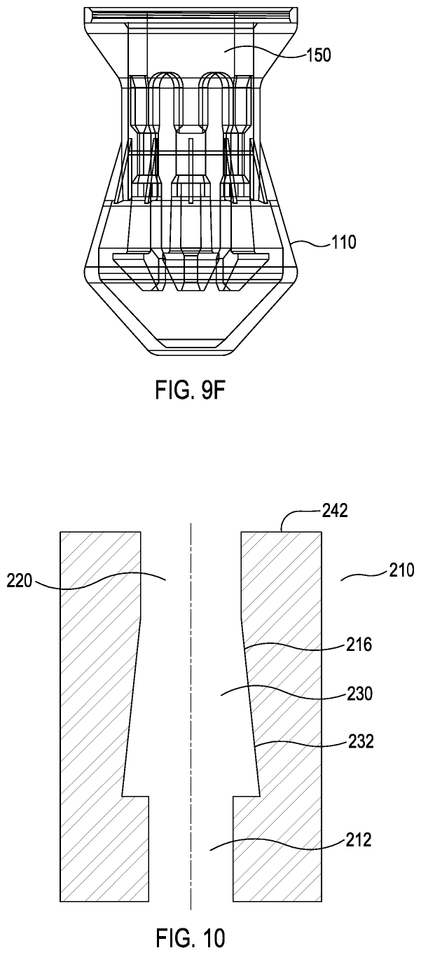

FIG. 10 is a cross-sectional view of a female part of a second apparatus according to the disclosure;

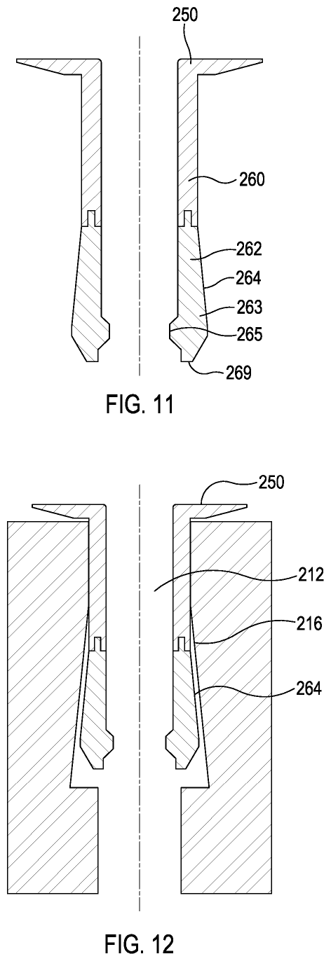

FIG. 11 is a cross-sectional view of a sleeve of the second apparatus;

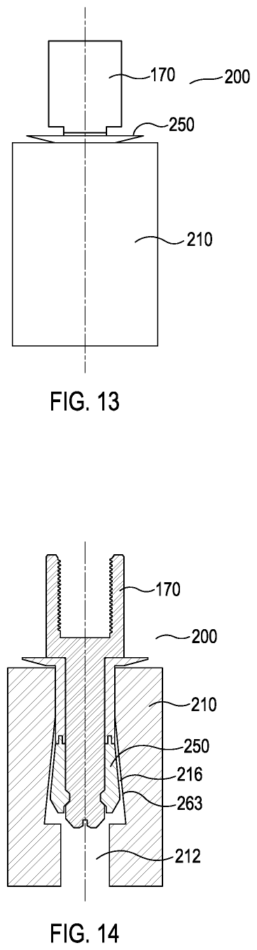

FIG. 12 is a cross-sectional view of the sleeve of the second apparatus inserted into the female part of the second apparatus;

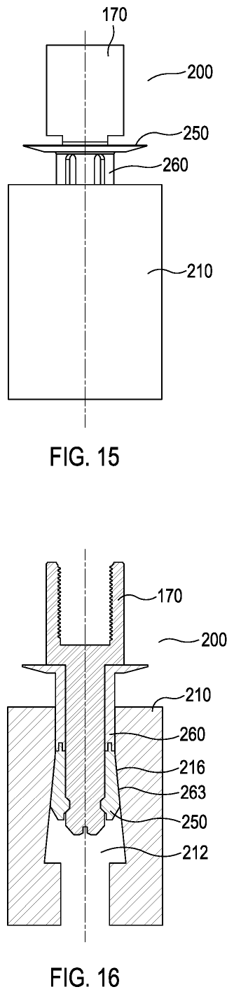

FIG. 13 is a side view of the second apparatus in a first condition;

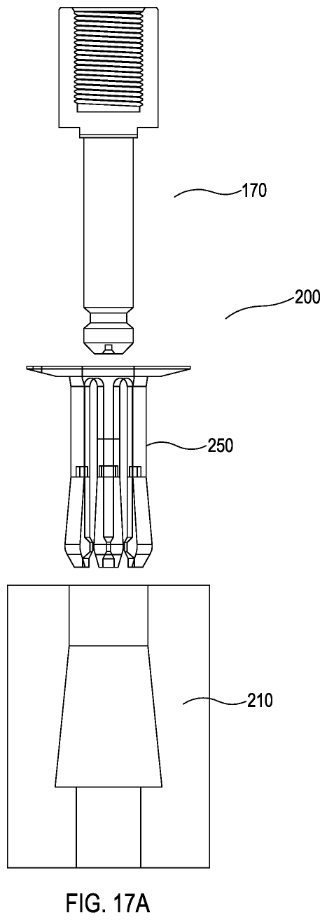

FIG. 14 is a cross-sectional view of the second apparatus in the first condition;

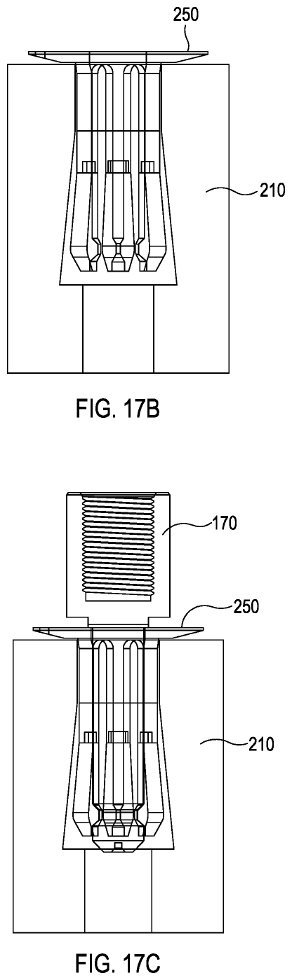

FIG. 15 is a side view of the second apparatus in a second condition;

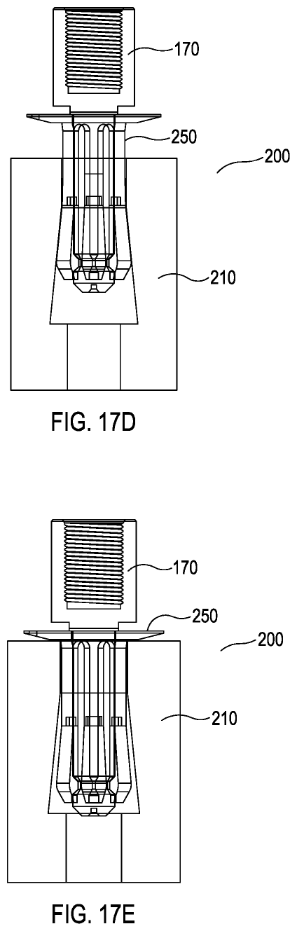

FIG. 16 is a cross-sectional view of the second apparatus in the second condition; and

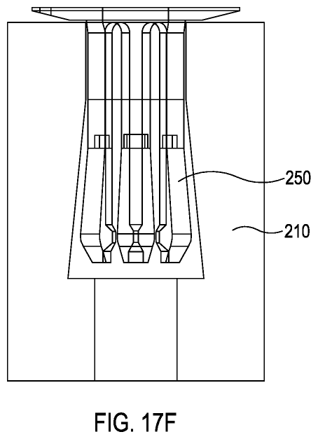

FIGS. 17A to 17F are see-through views showing the operation of the second apparatus.

### DETAILED DESCRIPTION

Female Part

FIG. 1 shows a female part 110 of a first example apparatus 100 for use in lifting or pulling objects. The object could for instance be a block formed from a settable material, such as a concrete slab, into which the female part 110 could be set by casting concrete around the female part 110. The female part 110 may be made from a plastics material.

The female part 110 includes a hole 112 extending into the female part 110, which in this example is a blind hole. The hole 112 includes a first portion 120 and a second portion 130. The first portion 120 is narrower than the second portion 130. The hole 112 extends into the female part from an outer opening 114, with the first portion 120 of the hole 112 being positioned between the second portion 130 of the hole and the outer opening 114.

In this example, the hole 112 is elongate. The length dimension of the hole 112 is aligned with a longitudinal axis 20 of the female part 110. The second portion 130 of the hole 112 is wider than the first portion 120 of the hole 112, i.e. in this example the second portion 130 of the hole 112 has a greater extent than the first portion 120 of the hole 112 in a dimension perpendicular to the longitudinal axis 20. In the example of FIGS. 1-9, the longitudinal cross section of the first and second portions 120, 130 of the hole 112 is substantially circular, which is shown more clearly in FIGS. 5, 7 and 9. In other examples the hole 112 could have a differently shaped longitudinal cross section, such as a square cross section.

An abutment surface 116 is located inside the female part 110. As shown in FIG. 1, the abutment surface 116 is provided between the first portion 120 and the second portion 130 of the hole 112. The abutment surface 116 extends radially outwardly from the narrower first portion 120 to the second portion 130. In this example, the abutment surface 116 extends radially outwardly from the first portion 120 at an angle of substantially 80° with respect to the longitudinal axis. In other examples, the abutment surface 116 may extend radially outwardly at other angles.

The abutment surface 116 of the female part 110 is inclined relative to the longitudinal axis such that it faces at least partially in a first direction illustrated by the arrow labelled with reference numeral 21 in FIG. 1, and also faces at least partially towards the longitudinal axis 20. The first direction 21, might, in some examples, be groundwards. It can be defined more generally as a direction that is parallel to the longitudinal axis 20 of the female part 110 that extends away from the outer opening 114 of the female part 110.

The interior wall of the second portion 130 of the hole 112 includes a tapered section 132 adjacent to the abutment surface 116. The tapered section 132 extends radially outwardly from the abutment surface 116 in the first direction 21. The tapered section 132 extends radially outwardly in the first direction at a lesser angle 21 (in this example) 20° with respect to the longitudinal axis than the abutment surface 116.

A further tapered section 134 of the interior wall of the second portion 130 of the hole 112 extends radially inwardly in the first direction 21 to the end 136 of the hole 112.

In the first apparatus 100, the female part 110 further includes a lid receiving portion 140 adjacent to the outer opening 114, along with a lid (not shown). The lid is for preventing ingress of foreign material into the female part 110 when the female part 110 is not in use. The lid receiving portion 140 includes a shelf 142 extending radially outwardly from the outer opening 114 of the hole, and a projecting rim 144 extending around the perimeter of the shelf, for retaining the lid on the shelf 142 and over the outer opening 114. The retaining rim 144 may include threading 146 on its internal surface to engage with threading on the outer circumference of the lid. In use, the lid may be covered by a thin top layer of material such as sand or cement to cover the lid and female part 110 when not in use.

Sleeve

FIG. 2 shows a sleeve 150 of the first apparatus 100. FIG. 3 shows the sleeve 150 when inserted into the female part 110 of the first apparatus 100. The sleeve 150 comprises a plurality of arms 160 defining a channel 152 between the arms 160, and at least one of the arms 160 is flexible. The arms 160 of the sleeve 150 can be inserted into the hole of the female part 110 when the lid (not shown) of the female part 110 has been removed.

The arms 160 extend from a base 154, and are configured for insertion into the hole 112 in the female part 110 such that distal portions 162 of the arms 160 are at least partially positioned in the second portion 130 of the hole 112. The distal portion 169 of each arm 160 includes a distal end 169 of the arm 160. The distal end 169 is the tip of the arm 160. In this example, the sleeve 150 is substantially cylindrical to correspond with the shape of hole 112 of the female part 110. The channel 152 extending through the sleeve 150 between the arms 160 is substantially cylindrical, with the arms 160 being circumferentially disposed around the channel 152. In other examples where the hole 112 female part 110 has a different longitudinal cross section, the sleeve 150 is correspondingly shaped to the cross section of the hole 112.

In the example of FIGS. 2 to 9, the sleeve 150 comprises six arms 160, and all of the arms 160 are flexible. In other examples, the sleeve may for instance include between two and twelve arms 160, or more preferably between four and eight arms 160.

The channel 152 is for receiving a male part 170 (an example male part is shown in FIGS. 4-9) including a distal stop 172. The channel 152 includes an outer opening 158 at an opposite end of the channel 152 to the distal ends 169 of the arms.

In the example of FIGS. 2 to 9, the channel 152 through the sleeve 150 is elongate. The length dimension of the elongate channel 152 is aligned with a longitudinal axis 22 of the sleeve 150. When the sleeve 150 is inserted in to the hole 112, the longitudinal axes 20, 22 of the female part 110 and the sleeve 150 are parallel, and in this example they coincide.

Each flexible arm 160 includes a proximal portion 161 adjacent to the base 154, and the distal portion 162. In the example of FIGS. 2 to 9, the base 154 and the proximal portions 161 of the arms 160 are made from a flexible plastics material. The proximal portion 161 of each arm may include a thinned portion 163 for increasing the flexibility of the respective flexible arm 160, as shown in FIG. 2.

The distal portion 162 of each flexible arm 160 of the sleeve 150 includes an internal abutment surface 166 for abutting against the distal stop 172 of the male part 170. The internal abutment surface 166 extends into the channel 152 from each flexible arm 160, and is tapered. The internal abutment surface 166 of the sleeve 150 is inclined relative to the longitudinal axis 20 such that it faces at least partially in a second direction illustrated by the arrow labelled with the reference numeral 23 in FIG. 2, and also faces at least partially towards the longitudinal axis 22 of the sleeve 150. The second direction 22 is defined as a direction that is parallel to the longitudinal axis 22 of the sleeve 150 that extends away from the outer opening 158 of the sleeve 150. When the sleeve 150 is inserted in to the hole 112, the longitudinal axes 20, 22 the first and second directions 21, 23 coincide.

The at least one flexible arm 160 of the sleeve 150 of the first apparatus 100 includes an internal projection 165 extending into the channel 152. The internal projection 165 includes the internal abutment surface 166 of the sleeve 150, which in this example is in the form of a tapered portion 166 at the distal end of the internal projection 165. In the example of FIGS. 2 to 9, the projection 165 is in the shape of an acute trapezoid, and therefore the projection also includes a proximal tapered surface 167.

The distal portion 162 of each flexible arm 160 includes an external projection 163 extending radially outwardly from the arm 160 in a direction away from the channel 152. The external projection 163 includes an external abutment surface 164 for abutting against the abutment surface 116 of the female part 110. The external abutment surface 164 of the projection 163 of each flexible arm 160 faces at least partially in a direction opposite to the second direction 23, and in this example faces at least partially away 22 from the longitudinal axis of the sleeve 150. The sleeve 150 of the first apparatus 100 is configured such that the external abutment surface 164 extends radially outwardly from sleeve 150 at an angle with respect to longitudinal axis 22 of the sleeve 150 that is substantially the same as the angle of the abutment surface 116 with respect to the longitudinal axis 20 of the female part 110, when the sleeve 150 is located in the hole 112 of the female part 150. In this example, the sleeve 150 of the first apparatus 100 is configured such that the external abutment surface 164 extends radially outwardly from sleeve 150 at an angle of 80° with respect to the longitudinal axis 22 of the sleeve 150.

The distal end 169 of each flexible arm 160 includes an outer tapered surface 168 on the opposite side of the respective flexible arm 160 to the channel 152, such that each flexible arm 160 to facilitate location of the distal end 169 of each flexible arm 169 into the opening 114 of the hole 112 of the female part 110.

In this example, the distal portion 162 of the at least one flexible arm 160 of the sleeve 150 is made from metal, which may be steel.

The sleeve 150 of the first apparatus 100 further includes an external flange 156 extending from the base 154 of the sleeve 150. The external flange 156 enables a user to hold the sleeve 150 in the hole 112 of the female part 110, when the arms 160 of the sleeve 150 are located in the hole 112.

Male Part

FIG. 4 shows the male part 170 of the first apparatus 100. The male part 170 includes the distal stop 172, and the male part 170 is for insertion into the channel 152 of the sleeve 150. In this example, the distal stop 172 is formed by a section of the male part which tapers radially outwardly.

The male part 170 is arranged such that, when the distal portions 162 of the arms 160 are at least partially positioned in the second portion 130 of the hole 112 of the female part 110 and a distal portion 180 of the male part 170 is positioned in the channel 152 and the distal stop 172 is positioned in the second portion 130 of the hole 112, application of a force to attempt to remove the male part 170 from the sleeve 150 causes the female part 110 to constrain movement of the distal portions 162 of the arms 160 in the second portion 130 of the hole 112. This prevents removal of the sleeve 150 from the female part 110. Constraining the movement of the distal portions 162 of the arms 160 in the second portion 130 of the hole 112 causes the distal stop 172 to prevent removal of the male part 170 from the sleeve 150.

The distal portion 180 of the male part 170 is for insertion into the channel 152 of the sleeve 150. In this example, the distal end 184 of the male part includes a tapered portion 186, to facilitate location of the distal portion 180 of the male part 170 into the channel 152.

In the example of FIGS. 4 to 9, the distal portion 180 of the male part 170 is elongate. The length dimension of the distal portion 180 is aligned with a longitudinal axis 24 of the male part 170. The male part 170 is arranged such that, when the distal stop 172 abuts against the internal abutment surface 166 of the sleeve 150, the distal stop 172 retains the arms 160 of the sleeve 150 wider than the width of the first portion 120 of the hole 112. That is, the arms 160 are retained at a greater extent than the first portion 120 of the hole 112, in a dimension perpendicular to the longitudinal axis 24 of the male part 170. In this example, the distal portion 180 of the male part 170 is substantially cylindrical to correspond to the shape of the channel 152 of the sleeve 150.

The outer surface of the distal stop 172 of the male part 170 faces at least partially in a third direction illustrated by the arrow labelled with the reference numeral 25 in FIG. 4, and also faces at least partially away from the longitudinal axis 24 of the male part 170. The third direction 24 is defined as a direction parallel to the longitudinal axis 24 of the male part 170 that extends away from the distal end 184 of the male part 170. When the male part 170 is inserted into the sleeve 150, the longitudinal axes 22, 24 coincide and the second and third directions 23, 25 oppose one another.

The distal stop 172 of the male part 170 of the first apparatus 100 is provided by a tapered distal end of a recess 182 in the distal portion 180 of the male part 170. In this example, the proximal end 183 of the recess 182 is also tapered, such that the recess 182 is in the shape of an acute trapezoid.

A mounting portion 190 is provided at the proximal end of the male part 170. The mounting portion 190 has a greater width than the elongate distal portion 180. That is, it extends to a greater extent than the elongate distal portion 180 in a dimension perpendicular to the longitudinal axis of the male part 170. The mounting portion 190 includes means 192 for fastening the male part 170 to a lifting or pulling device. In this example the means 192 for fastening the male part 170 to a lifting or pulling device is in the form of an internal thread. The internal thread 192 could be used for example to threadably insert a lifting eye, or to directly attach a crane to the male part 170. In other examples, rather than an internal thread, a lifting eye could for instance be integrally formed into the mounting portion 190 to provide means 192 for fastening the male part 170 to a lifting or pulling device.

First Condition

FIGS. 5 & 6 illustrates the first apparatus 100 including the female part 110, the sleeve 150 and the male part 170, when the sleeve 150 is inserted into the hole 112 and the male part 170 is inserted into the channel 152 of the sleeve 150. FIGS. 5 & 6 show the first apparatus 100 is a first condition, where no force is being applied to attempt to remove the male part 170 from the sleeve 150. The male part 170 may be made from metal, such as steel.

FIG. 5 is a side view of the first apparatus 100, showing an outer surface of the female part 110. In the first apparatus 100, the female part 110 includes a brace 118, which extends between the outer wall of the abutment surface 116 of the female part 110, and the outer wall of the first portion 120 of the hole 112. The brace strengthens the structure of the female part 110. In this example, the brace 118 is in the form of multiple buttresses provided around the circumference of the female part 110.

As demonstrated in FIGS. 5 and 6, when the sleeve 150 is inserted in to the hole 112, and when the male part 170 is inserted into the channel 152 of the sleeve 150, the longitudinal axes 20, 22, 24 of the female part 110, the sleeve 150, and the male part 170 are parallel, and in this example they coincide. Furthermore, the first and second directions 21, 23 coincide when the sleeve 150 is inserted in to the hole 112. In addition, when the male part 170 is inserted into the channel 152 of the sleeve 150, the third direction 25 is opposite to the first and second directions 21, 23.

The internal projection 165 of each flexible arm 160 of the sleeve is for insertion into the recess 182 of the male part 170. The tapering of the internal abutment surface 166 of the internal projection 165 enables the distal stop 172 of the male part 170 to be slidably moved beyond the internal abutment surface 166 of the sleeve 150 when the flexible arms 160 are able to flex outwardly. In the example of FIGS. 2 to 9, the projection 165 is shaped to substantially correspond to the shape of the recess 182 in the distal portion 180 of the male part 170, and in this particular example this shape is an acute trapezoid.

A release means is provided for releasing the male part 170 from the channel 152 of the sleeve 150. In the first assembly 100, the release means includes the external flange 156 of the sleeve 150. The external flange 156 enables a user to hold the sleeve 150 in the hole 112, such that the distal stop 172 of the male part 170 can be pulled through the channel 152, without also pulling the sleeve 150. In some examples, a resilient member (not shown) such as a spring may be provided between the shelf 142 of the female part 110 and the external flange 156 of the sleeve 150, to prevent the flange 156 being held down by for instance an object or material that has unintentionally fallen onto the flange 156.

Second Condition

FIGS. 7 and 8 illustrate the first apparatus 100 in a second condition. In the second condition, a force is being applied to attempt to remove the male part 170 from the sleeve 150, when the sleeve 150 is located in the hole 112, and the male part 170 is located in the channel 152 of the sleeve 150. Thus, the distal portions 162 of the arms 160 are at least partially positioned in the second portion 130 of the hole 112, the distal portion 180 of the male part 170 is positioned in the channel 152, and the distal stop 172 is positioned in the second portion 130 of the hole 112.

When such a force is being applied, the external abutment surface 164 of the sleeve 150 abuts against the abutment surface 116 of the female part 110, urging the arms 160 of the sleeve 150 towards the channel 152. The internal abutment surface 166 of the sleeve 150 is therefore urged against the distal stop 172 of the male part 170, which prevents the distal portions 162 of the flexible arms 160 from flexing into the channel 152. In this example, the internal projection 165 on each arm 160 of the sleeve 150 is urged into the recess 182 of the distal portion 180 of the male part 170 when the force is being applied to attempt to remove the male part 170 from the sleeve 150.

This causes the female part 110 to constrain movement of the distal portions 162 of the arms 160 in the second portion 130 of the hole, thereby preventing removal of the sleeve 150 from the female part 110. Constraining the movement of the distal portions 162 of the arms 160 in the second portion 130 of the hole 112 causes the distal stop 172 to prevent removal of the male part 170 from the sleeve 150.

Operation of the Apparatus

FIGS. 9A to 9F show the operation of the first apparatus 100. FIG. 9A shows the female part 110, sleeve 150 and male part 170 separated from one another. The female part 110 may for instance be set into a concrete slab to enable the first apparatus 100 to be used in lifting the slab. Firstly, the lid (not shown) of the female part 110 is removed, and then the sleeve 150 is inserted into the hole 112 of the female part 110, as shown in FIG. 9B, which corresponds to FIG. 3. The male part 110 is then inserted into the sleeve 150 to place the first apparatus 100 in the first condition, as shown in FIG. 9C, which corresponds to FIGS. 5 & 6.

The means 192 for fastening the male part 170 to a lifting or pulling device may then be used to fasten the male part 170 to a lifting or pulling device, such as a crane.

A pulling or lifting force is then applied to the male part 170 along the longitudinal axis of the male part 170 to attempt to remove the male part from the sleeve 150. This places the first apparatus 100 in a second condition, as is shown in FIG. 9D, which corresponds to FIGS. 7 & 8. When the lifting or pulling force is being applied, the female part 110 is lifted or pulled, along with any objects fastened to the female part 110, such as a concrete slab.

Once lifting or pulling has been completed, and the pulling or lifting force is no longer applied, the first apparatus 100 returns to the first condition, as shown in FIG. 9E. The release means is then used to release the male part 170 from the channel 152 of the sleeve 150. In this example, the external flange 156 of the sleeve 150 is held by a user to urge the sleeve 150 into the hole. Whilst the external flange 156 is held and the male part 170 is being pulled from the channel 152 of the sleeve 150, the spacing between the flexible arms 160 and the wall of the second portion 130 of the hole 112 is sufficient to enable the distal stop 172 of the male part 170 to urge the flexible arms 160 outwardly and move out of the channel 152 of the sleeve 150.

Once the male part 170 has been removed from the sleeve 150, as shown in FIG. 9F, the sleeve 150 can then be removed from the female part 110. In some examples, such as in the first apparatus 100 of FIGS. 1-7, the flexible arms 160 of the sleeve 150 may be required to flex inwardly to enable removal of the sleeve 150 from the female part 110. This is facilitated by the tapering of either the abutment surface 116 of the female part 110, and/or the tapering of the external abutment surface 164 of the sleeve 150.

Once removed from the female part 110, the male part 170 and sleeve 150 can be reused, and the lid (not shown) can be placed in the lid receiving portion 140 of the female part 110.

Second Apparatus

FIGS. 10 to 17 illustrate a second example apparatus 200 for use in lifting or pulling objects, with the views of FIGS. 8 to 14 corresponding to those of FIGS. 1, 3, and 5 to 9 for the first apparatus 100 respectively. The second apparatus 200 is similar to the first apparatus 100, with a number of differences.

The female part 210 of the second apparatus 200 includes a through hole 212. The female part 210 of the second apparatus 200 may be a block of metal or concrete, with the metal or concrete being cast around the hole 212, for instance using a removable or degradable mould.

The tapered section 232 of the second portion 230 of the hole of the female part 210 extends radially outwardly at substantially the same angle as the abutment surface 216 with respect to the longitudinal axis of the female part 210. This spreads the load through a greater portion of the walls of the hole 212 of the female part 210 when pulling or lifting an object, as shown for instance in FIG. 13.

Furthermore, the female part 210 of the second apparatus 200 does not include a lid or a lid receiving portion, but does include a shelf 242.

The internal projection 265 on each flexible arm 260 of the sleeve 250 of the second apparatus 200 is spaced from the distal end 269 of the respective arm 260, rather than being provided adjacent to the distal end 269 of the respective arm 260 as in the first apparatus 100.

The external projection 263 on the distal portion 262 of each flexible arm 260 includes an external abutment surface 264 that is configured to extend radially outwardly from sleeve 250 at an angle with respect to the longitudinal axis of the sleeve 250 that is substantially the same as the angle of the abutment surface 216 of the female part 210 with respect to the longitudinal axis of the female part 210 of the second apparatus 200. In this example, the sleeve 250 of the first apparatus 200 is configured such that the external abutment surface 264 extends radially outwardly from sleeve 250 at an angle of 7.5° with respect to the longitudinal axis of the sleeve 250.

Third and Fourth Apparatuses

A third apparatus for use in pulling or lifting objects is also disclosed herein. The third apparatus includes a male part and a sleeve, which could be for instance the male part 170 and the sleeve 150 of the first or second apparatuses 100, 200.

The sleeve 150, 250 comprises a plurality of arms 160, 260, and at least one of the arms is flexible. The plurality of arms 160, 260 defines a channel 152. The arms 160, 260 are configured for insertion into a hole 112, 212 including a first portion 120, 220 and a second portion 130, 230, the first portion 120, 220 of the hole 112, 212 being narrower than the second portion 130, 230 of the hole 112, 212, such that distal portions 162, 262 of the arms 160, 260 of the sleeve 150, 250 are at least partially positioned in the second portion 130, 230 of the hole 112, 212 when the arms 160, 260 are inserted into the hole 112, 212. The hole 112, 212 into which the arms 160, 260 are configured to be inserted could for example be the holes 112, 212 in the female parts 110, 210 of the first and second apparatuses 100, 200.

The male part 170 is for insertion into the channel 152 of the sleeve 150, 250. The male part 170 comprises a distal stop 172, and the male part 170 is arranged such that, when the distal portions 162, 262 of the arms 160, 260 are at least partially positioned in the second portion 130, 230 of the hole 112, 212 and a distal portion 172 of the male part 170 is positioned in the channel 152 and the distal stop 172 is positioned in the second portion 130, 230 of the hole 112, 212, application of a force to attempt to remove the male part 170 from the sleeve 150, 250 causes the female part 110, 210 to constrain movement of the distal portions 162, 262 of the arms 160, 260 in the second portion 130, 230 of the hole 112, 212. This prevents removal of the sleeve 150, 250 from the female part 110, 210. Constraining movement of the distal portions 162, 262 of the arms 160, 260 in the second portion 130, 230 of the hole 112, 212 causes the distal stop 172 to prevent removal of the male part 170 from the sleeve 150, 250.

The third apparatus could be for instance be inserted into a hole in a concrete slab, a wall or a floor, for use in pulling/lifting an object relative to the slab, wall or floor. For example, the third apparatus could be used to anchor/pull a ship to a harbour wall, which harbour wall has a hole formed therein, the hole including a first portion and a second portion, the first portion of the hole being narrower than the second portion of the hole.

A fourth apparatus for use in pulling or lifting objects is also disclosed herein. The fourth apparatus includes a female part and a sleeve. The female part and the sleeve of the fourth apparatus could be for instance the female part 110 and the sleeve 150 of the first apparatus 100 as shown in FIG. 2, or the female part 210 and the sleeve 250 of the second apparatus 200 as shown in FIG. 9.

The female part 110, 210 includes a hole extending into the female part 110, 210. The hole includes a first portion 120, 220 and a second portion 130, 230, the first portion 120, 220 being narrower than the second portion 130, 230.

The sleeve 150, 250 comprises a plurality of arms 160, 260, and at least one of the arms 160, 260 is flexible. The plurality of arms 160, 260 defines a channel 152. The arms 160, 260 are configured for insertion into the hole 112, 212 in the female part 110, 210 such that distal portions 162, 262 of the arms 160, 260 are at least partially positioned in the second portion 130, 230 of the hole 112, 212. The channel 152 is for receiving a male part 170 including a distal stop 172. The distal portion 162, 262 of the at least one flexible arm 160, 260 includes an abutment surface for abutting against the distal stop 172 of the male part 170, such that when the distal portions 162, 262 of the arms 160, 260 are at least partially positioned in the second portion 130, 230 of the hole 112, 212 and a distal portion 172 of the male part 170 is positioned in the channel 152 and the distal stop 172 is positioned in the second portion 130, 230 of the hole 112, 212, application of a force to attempt to remove the male part 170 from the sleeve 150, 250 causes the female part 110, 210 to constrain movement of the distal portions 162, 262 of the arms 160, 260 in the second portion 130, 230 of the hole 112, 212. This prevents removal of the sleeve 150, 250 from the female part 110, 210. Constraining movement of the distal portions 162, 262 of the arms 160, 260 in the second portion 130, 230 of the hole 112, 212 causes the distal stop 172 to prevent removal of the male part 170 from the sleeve 150, 250. The male part 170 which the sleeve 150, 250 is suitable for being received on could for instance be the male part 170 of the first or second apparatuses 100, 200.

The fourth apparatus could be for instance be inserted onto a male part formed on a concrete slab, a wall or a floor, for use in pulling/lifting an object relative to the slab, wall or floor. For example, the fourth apparatus could be used to anchor/pull a ship to a harbour wall, which harbour wall has a male part with a distal stop formed thereon.

There is thus described an apparatus for use in pulling or lifting objects with a number of advantages. When used with concrete, the system becomes more secure over time, rather than less secure, due to the concrete hardening with age. The system is more cost efficient relative to prior arrangements, as the sleeve and/or male part are reusable. Due to the lower cost of materials, it is possible to anchor the female part more deeply in a settable material such as concrete, to spread the load over a larger base, enabling larger loads to be passed through the apparatus. The apparatus can be used in pulling or lifting objects of different sizes and weights.

The apparatus could be used in applications such as the towing of objects or vehicles. In this instance the sleeve, male part and female part may be substantially non-cylindrical, such that the male part is rotatably fixed when located in the female part.

Various other modifications may be made without departing from the scope of the invention. A differently shaped sleeve, male part or female part may be used. For instance, each part could have a substantially square longitudinal cross section, rather than a substantially circular longitudinal cross section. In some examples, the arms of the sleeve may initially be narrower than the first portion of the hole of the female part, and become wider than the first portion of the hole once engaged by the distal stop of the male part.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

I/We claim:

1. An apparatus for use in lifting or pulling an object, the apparatus comprising:
a female part including a hole extending into the female part, wherein the hole includes a first portion and a second portion, the first portion being narrower than the second portion;
a sleeve comprising a plurality of arms, at least one of which is flexible, the plurality of arms defining a channel, the arms being configured for insertion into the hole in the female part such that distal portions of the arms are at least partially positioned in the second portion of the hole; and
a male part, for insertion into the channel of the sleeve, comprising a distal stop, wherein the male part is arranged such that, when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

2. An apparatus according to claim 1, wherein the distal stop tapers radially outwardly from the male part.

3. An apparatus according to claim 1, wherein the distal stop is provided by a distal end of a recess in the distal portion of the male part.

4. An apparatus according to claim 3, wherein the distal end of the recess of the male part is tapered.

5. An apparatus according to claim 3, wherein the proximal end of the recess of the male part is tapered.

6. An apparatus according to any of claim 3, wherein the at least one flexible arm includes an internal projection extending into the channel for insertion into the recess.

7. An apparatus according to claim 6, wherein the internal projection of the at least one flexible arm includes a tapered portion at its distal end, to enable the projection to be slidably removed from the recess of the male part.

8. An apparatus according to claim 6, wherein the projection is shaped to substantially correspond to the shape of the recess in the distal portion.

9. An apparatus according to claim 1, wherein the distal end of the male part includes a tapered portion to facilitate location of the male part into the channel.

10. An apparatus according to claim 1, wherein the distal end of the at least one flexible arm includes an outer tapered surface extending radially outwardly from the at least one flexible arm in a direction away from the channel, to facilitate location of the at least one flexible arm into the hole.

11-22. (canceled)

23. An apparatus according to claim claim 1, wherein the hole includes an abutment surface between the first portion and the second portion, the abutment surface extending radially outwardly from the first portion to the second portion.

24. An apparatus according to claim 23, wherein the abutment surface is tapered.

25. An apparatus according to claim 23, wherein the at least one flexible arm of the sleeve includes an external projection extending radially outwardly from the channel for abutting against the abutment surface of the female part.

26. (canceled)

27. An apparatus according to claim 1, wherein the hole is a blind hole.

28. An apparatus according to claim 23, wherein the second portion of the hole includes a tapered section adjacent to the abutment surface, which tapered section extends radially outwardly.

29. An apparatus for use in lifting or pulling an object, the apparatus comprising:
a female part including a hole extending into the female part, wherein the hole includes a first portion and a second portion, the first portion being narrower than the second portion; and
a sleeve comprising a plurality of arms, at least one of which is flexible, the plurality of arms defining a channel, the arms being configured for insertion into the hole in the female part such that distal portions of the arms are at least partially positioned in the second portion of the hole, wherein the channel is for receiving a male part including a distal stop, wherein the distal portion of the at least one flexible arm includes an abutment surface for abutting against the distal stop of the male part, such that when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

30. An apparatus for use in lifting or pulling an object, the apparatus comprising:
a sleeve comprising a plurality of arms, at least one of which is flexible, the plurality of arms defining a channel, and the arms are configured for insertion into a hole of a female part, the hole including a first portion and a second portion, the first portion of the hole being narrower than the second portion of the hole, such that distal portions of the arms of the sleeve are at least partially positioned in the second portion of the hole when the arms are inserted into the hole; and
a male part, for insertion into the channel of the sleeve, comprising a distal stop, wherein the male part is arranged such that, when the distal portions of the arms are at least partially positioned in the second portion of the hole and a distal portion of the male part is positioned in the channel and the distal stop is positioned in the second portion of the hole, application of a force to attempt to remove the male part from the sleeve causes the female part to constrain movement of the distal portions of the arms in the second portion of the hole, thereby preventing removal of the sleeve from the female part, wherein constraining movement of the distal portions of the arms in the second portion of the hole causes the distal stop to prevent removal of the male part from the sleeve.

31. An apparatus according to claim 23, wherein the hole is elongate and defines a longitudinal axis, and wherein the abutment surface of the female part extends radially outwardly from the first portion to the second portion of the hole at an acute angle closer to 90° than 0°, relative to the longitudinal axis.

32. An apparatus according to claim 31, wherein the abutment surface of the female part extends radially outwardly from the first portion to the second portion at an angle of between 75° and 85°, relative to the longitudinal axis.

33. An apparatus according to claim 32, wherein the abutment surface of the female part extends radially outwardly from the first portion to the second portion at an angle of substantially 80°, relative to the longitudinal axis.
